(19) United States
(12) Patent Application Publication
(10) Pub. No.: US 2011/0247926 A1
(43) Pub. Date: Oct. 13, 2011

(54) INTERNAL VENTING DOME SWITCH

(75) Inventors: Jay Osborn, Palo Alto, CA (US); Tomas Ponce, San Carlos, CA (US)

(73) Assignee: Apple Inc., Cupertino, CA (US)

(21) Appl. No.: 12/757,281

(22) Filed: Apr. 9, 2010

(51) Int. Cl. H01H 3/12

(52) U.S. Cl. 200/515

(57) ABSTRACT

To substantially prevent debris from entering the internal volume of a dome switch, the dome switch can be configured to include limited or no external vents. However, to ensure that the air can be displaced and to avoid an excessively high pressure underneath the dome with the dome is inverted, the dome switch can include one or more internal regions for receiving the displaced air. In particular, the dome switch may include one or more integrated reservoirs. For example, the integrated reservoirs can be placed in a layer between a film placed over the dome and a circuit board on which the dome is placed. As another example, the integrated reservoirs can be constructed out of the plane of the circuit board.

### BACKGROUND OF THE INVENTION

This is directed to a dome switch having substantially limited or no external or environmentally exposed openings for expelling air.

Users can provide inputs to electronic devices using many different approaches. One common approach can include a dome switch. The dome switch is typically constructed by placing a conductive dome over a contact pad on a circuit board. In most cases, the dome is attached to the circuit board with tape that covers the dome and a portion of the circuit board. When the dome is pressed, the dome can invert such that the inner surface of the dome contacts the contact pad. The dome inversion also provides a tactile ‘click’ that enhances the user's interaction with the switch. In some cases, a cosmetic piece may be placed over the dome to form a button. In response to the user pressing the cosmetic piece, the dome is in turn depressed and contacts the contact point thereby generating an input.

Dome switches typically define an internal volume and can include a plurality of openings in order vent the interior volume to the environment. For example, when the dome is collapsed to close a circuit, air can be expelled from the internal volume through the openings, thereby helping remove air pressure resistance to the dome movement. Air can re-enter the internal volume through the openings when the dome reverts to its initial position. The openings may be disposed through tape member and in some circumstances the dome as well.

While this arrangement may work well, in some circumstances, the openings in the dome switch can provide a path for debris, water, or other external particles. This can effect the proper operation of the dome switch. For example, the external substances may plug the openings thereby disrupting the venting and/or the external substances may enter the internal volume, which can lead to mechanical and/or electrical disruption (e.g., binding, corrosion, or short). By way of example, if a conductive particle infiltrates the internal volume, the particle can cause a short between the conductive pad of the circuit board and the dome.

### SUMMARY OF THE INVENTION

A dome switch that includes an internal venting mechanism is provided. In particular, a dome switch can include a venting pocket integrated between a circuit board and a film used to retain a dome to the circuit board.

A dome switch can include a dome placed over contact pads of a circuit board. When the dome is depressed or inverted, the dome can provide a conductive path between the contact pads. To ensure that the force required to depress the dome is not excessive, it may be necessary to expel air from underneath the dome (e.g., to ensure that the air pressure within the dome switch is not too large). The excess air can be expelled in any suitable manner. Some domes include vents for venting the excess air. This approach, however, can lead to debris or foreign particles getting into the dome switch and preventing it from functioning properly.

In some embodiments, the dome can instead have no vents. To ensure that the air underneath the dome can be expelled from the dome switch so that the dome switch has a desired response, the dome switch can include one or more reservoirs for receiving expelled air. The reservoirs can be connected to the volume underneath the dome using any suitable approach. In some embodiments, reservoirs can be directly connected to the volume. Alternatively, one or more vias or passageways can connect the reservoirs to the internal volume of the dome switch.

The reservoirs can be distributed around the dome using any suitable approach. In some embodiments, the reservoirs can be distributed substantially along the plane of the circuit board. Alternatively, the reservoirs can be distributed substantially along the height of the dome switch. For example, a reservoir can be higher than it is wide. The reservoir can have any suitable volume, including for example a volume determined from the size of the dome.

The reservoir can be incorporated in any suitable component of an electronic device. In some embodiments, the reservoir can be incorporated as part of a dome switch. Alternatively, the reservoir can be incorporated as part of an other electronic device component, and connected to the internal volume of the dome switch using a passageway or via.

### BRIEF DESCRIPTION OF THE DRAWINGS

The above and other features of the present invention, its nature and various advantages will be more apparent upon consideration of the following detailed description, taken in conjunction with the accompanying drawings in which:

FIG. 1A is a schematic top view of an illustrative dome switch having vents;

FIG. 1B is a cross-sectional view of the illustrative dome switch of FIG. 1A;

FIG. 1C is a cross-section view of the illustrative dome switch of FIG. 1A when the dome is inverted;

FIG. 1D is a simplified block diagram of a dome switch arrangement in accordance with one embodiment of the present invention;

FIG. 2A is a cross-sectional view of an illustrative dome switch having a reservoir in accordance with one embodiment of the invention;

FIG. 2B is a top view of the illustrative dome switch of FIG. 2A when the dome and film have been removed in accordance with one embodiment of the invention;

FIG. 3 is a top view of an illustrative dome switch that includes a reservoir for receiving air expulsed by a dome during actuation in accordance with one embodiment of the invention;

FIG. 4 is a top view of an illustrative dome switch having a reservoir for receiving expelled air in accordance with one embodiment of the invention;

FIG. 5A is a bottom view of an illustrative dome switch having a reservoir constructed in a spacer in accordance with one embodiment of the invention;

FIG. 5B is a cross-sectional view of the dome switch of FIG. 5A in accordance with one embodiment of the invention;

FIG. 6 is a cross-sectional view of an illustrative dome switch having a reservoir extending along the dome height in accordance with one embodiment of the invention;

FIG. 7 is a schematic view of an illustrative circuit board over which a dome switch is placed in accordance with one embodiment of the invention;

FIG. 8 is a schematic view of an illustrative adhesive layer having a reservoir in accordance with one embodiment of the invention; and

FIG. 9 is a flowchart of an illustrative process for constructing a ventless dome switch in accordance with one embodiment of the invention.

### DETAILED DESCRIPTION

An electronic device can include several input interfaces for detecting inputs provided by a user. In particular, an electronic device can include one or more dome switches. In accordance with one embodiment, a dome switch can be environmentally or externally ventless. That is, the dome switch can have substantially limited or no external or environmentally exposed openings for expelling air when depressed or receiving air when brought back to its nominal state. In so doing, external particles may be prevented from disrupting the operation of the dome switch or contaminating contacts or other structures of the dome switch. In some embodiments, instead of external venting or venting to the environment outside the dome switch, the venting can be performed in an internally enclosed space or volume. For example, internally enclosed reservoirs, voids, channels, vias or pockets may be used to allow typical dome switch breathing—exhaling and inhaling of air. This can for example be accomplished through the various layers within and/or surrounding the dome switch.

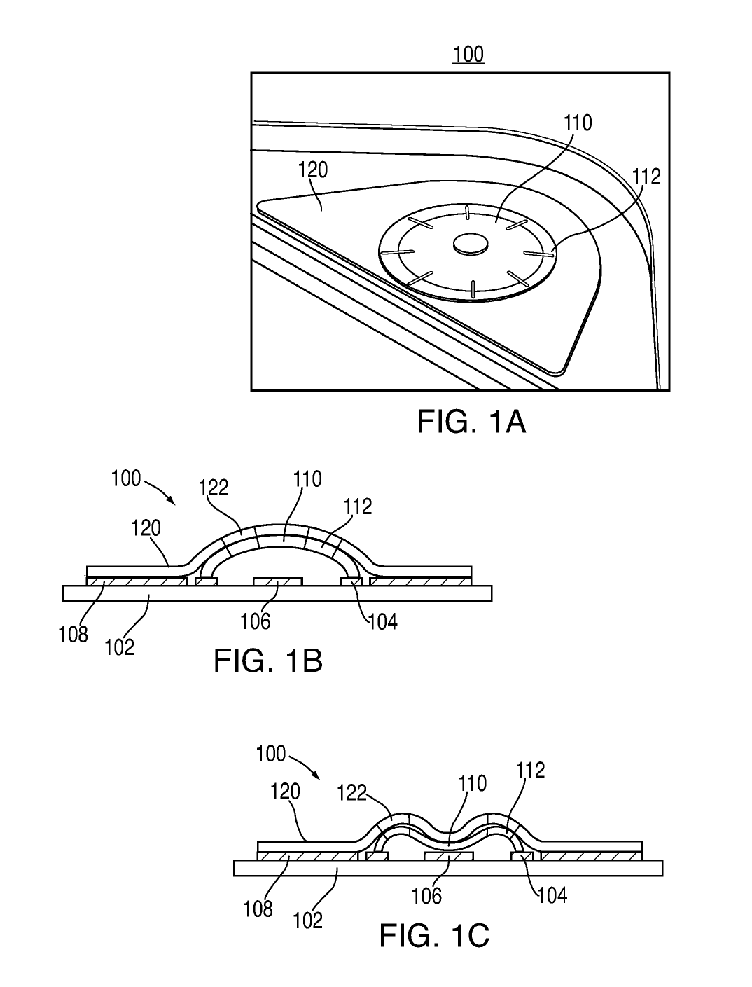

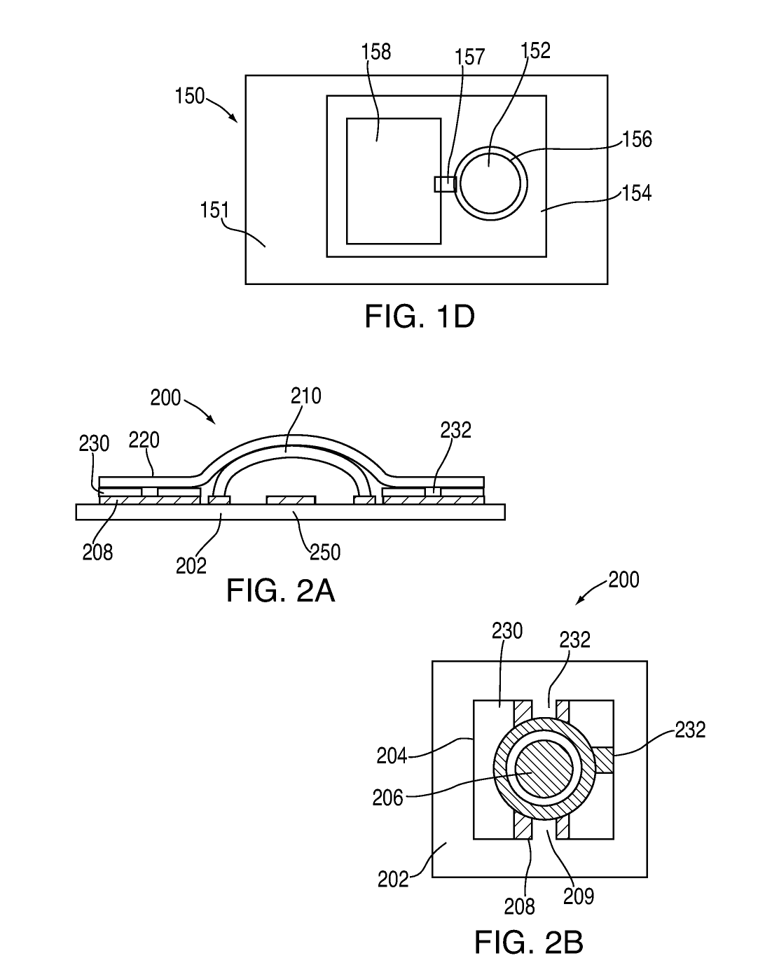

Embodiments are discussed below with reference to FIGS. 1-9. However, those skilled in the art will readily appreciate that the detailed description given herein with respect to these figures is for explanatory purposes as the invention extends beyond these limited embodiments.

FIG. 1A is a schematic top view of an illustrative dome switch having vents. FIG. 1B is a cross-sectional view of the illustrative dome switch of FIG. 1A. FIG. 1C is a cross-section view of the illustrative dome switch of FIG. 1A when the dome is inverted. Dome switch 100 can include dome 110 placed over circuit board 102. Circuit board 102 can include outer and inner contact pads 104 and 106, which are electrically isolated. The edge of dome 110 can be placed over and in contact with outer contact pad 104. When a user inverts dome 110, the internal surface of dome 110 can come into contact with inner contact pad 106, and serve as a conductive path between the contact pads (e.g., closing the circuit).

Dome 110 can be constructed from any suitable material. For example, dome 110 can be constructed from a conductive material (e.g., sheet metal). As another example, dome 110 can be constructed from a non-conductive material, but include a conductive coating applied to an internal surface of the dome (e.g., to the surface that comes into contact with the circuit board). Dome 110 can be constructed using any suitable approach, including for example stamping, machining, molding, or combinations of these.

The dome can be coupled to circuit board 102 using any suitable approach. For example, the dome can be coupled to the circuit board using a soldering or surface mount technology (SMT) process. In some embodiments, a film 120 or tape (e.g., an adhesive applied to a film) can be placed over dome 110 and adhered to circuit board 102 (e.g., trapping the dome between the film and circuit board). In some cases, switch 100 can include spacer 108 placed between film 120 and circuit board 102 to prevent the film from being applied too close to the surface of the circuit board. Spacer 108 can be constructed from any suitable material, including for example a non-conductive material (e.g., polycarbonate). Spacer 108 can have any suitable height, including for example a height in the range of 0.01 mm to 0.1 mm (e.g., 0.05 mm).

When dome 110 is pressed and inverted, air enclosed in the volume between dome 110 and circuit board 102 may need to be expelled so that the air pressure within the volume does not increase and prevent a user from inverting the dome. To allow the air to escape, dome 110 can include openings 112 in the surface of the dome. Dome 110 can include any suitable number of openings 112, including for example a number in the range of 0 to 15 (e.g., 8). In some embodiments, the number and size of the openings can be determined based on the size of the dome and the volume of air to be expelled from the dome during actuation. Each opening 112 can have any suitable shape or size, including for example the same or different shapes and sizes. In some embodiments, each opening 112 can substantially define a slot. To ensure that air can escape from switch 100, film 120 can include openings 122 corresponding to openings 112 of dome 110 (e.g., aligned). In some cases (e.g., when a film is used to trap or secure dome 110), dome 110 can include no openings, but allow air to escape from around the bottom periphery of the dome and through openings in the film (e.g., pressure causes the dome to rise off the surface and allows air to be expelled).

Because openings 112 provide a path between the environment and the area within switch 100, external particles, debris, or liquid (e.g., water or sweat) can infiltrate the area of circuit board 102 covered by the dome, which can cause mechanical and/or electrical disruptions or failure of the dome switch. For example, debris or liquid may cause switch 100 to short. Furthermore, such contaminates can initiate or introduce corrosion resulting in shortening of service life or causing switch failure.

To prevent this, in some embodiments a dome switch with limited or no external vents can be provided. The switch may include one or more internal regions where the air can be moved in and out when the dome is positioned between its nominal and depressed or inverted positions. In essence, this embodiment provides for internal or enclosed venting of the dome switch. By way of example, the internal venting may be performed with channels, vias, pockets, reservoirs and the like built into the various layers surrounding the dome switch including but not limited to printed circuit boards, spacers, etc. These features can be in fluid communication with the internal volume of the dome switch (e.g., area defined by the dome and the printed circuit board). In some cases, additional layers may be provided to further aid in forming the internal venting volume. For example, pockets may be formed with additional films in fluid communication with the internal volume of the dome switch.

FIG. 1D is a simplified block diagram of a dome switch arrangement in accordance with one embodiment of the present invention. Dome switch arrangement 150 can be placed within an environment 151. The dome switch arrangement 150 includes a dome 152 and a substrate 154 that define an internal volume 156. The dome may for example be a metal dome and the substrate may be a printed circuit board although this is not a requirement. The dome 152 is configured to move inwardly under a force into the internal volume 156 and towards the substrate 154. By moving inwardly, an input signal is created. For example, the dome 152 may close a circuit thereby generating the input signal.

The dome switch arrangement 150 can further include a second internal volume 158. The second internal volume can be formed from a variety of features or components that are directly or indirectly involved with the dome switch arrangement 150. By way of example, the second internal volume can be created by a spacer, film and/or a portion of the substrate. The second internal volume 158 can be fluidly coupled to the first internal volume 156. This may for example be accomplished through holes, passageways, openings, channels, vias, and the like (e.g., passageway 157). The second internal volume 158 can be at least as large as the displaced volume when the dome 152 is moved into the first internal volume 156. In some cases, second internal volume 158 can be smaller than the first internal volume while in other cases the second internal volume can be substantially the same as the first internal volume. During operation, when the dome is moved into the internal volume, air can be displaced into the second internal volume in order to help reduce any back pressure. As another way to describe this, when dome 152 is depressed, the dome can collapse and displace air from the first internal volume to close the switch. The displaced air can fill the second internal volume. In addition, because it is fully enclosed or internal (no external vents), external substances are prevented from entering the internal volume.

FIG. 2A is a cross-sectional view of an illustrative dome switch having a reservoir in accordance with one embodiment of the invention. FIG. 2B is a top view of the illustrative dome switch of FIG. 2A when the dome and film have been removed in accordance with one embodiment of the invention. Dome switch 200 can include circuit board 202, which can include some or all of the features of circuit board 102 (FIG. 1) In some embodiments, circuit board 202 can include contact pads 204 and 206 that are electrically isolated such that when dome switch 200 is closed, an electrical connection is created between the contact pads. Dome 210, which can include some or all of the features of dome 110 (FIG. 1), can be placed over circuit board 202 such that it is aligned with the contact pads. Unlike dome 110, however, dome 210 may not include any openings or vents through which air can escape dome switch 200 to the environment. In some cases, the external vents can instead be limited.

Dome 210 can be retained against circuit board 202 using any suitable approach, including for example one of those described in connection with dome switch 100 (FIG. 1). In one implementation, dome 210 can be retained against circuit board 202 by film 220 placed over dome 210 and adhered to circuit board 202 (e.g., using an adhesive included as part of film 220 or in addition to film 220). Dome switch 200 can in addition include spacer 208 (having some or all of the features of spacer 108, FIG. 1), which can facilitate the actuation of dome 210.

Dome switch 200 can include intermediate layer 230 placed between dome 210 and film 220. Layer 230 can be constructed from any suitable material, including for example a flexible material (e.g., a Mylar or plastic film), or a more rigid material. Layer 230 can include openings 232 extending from the boundary of dome 210 and defining regions between circuit board 202 or spacer 208 and film 220. Alternatively, layer 230 can include one or more pockets (e.g., formed within the volume of layer 230, and bound by material of layer 230) connecting with the volume underneath dome 210. When dome 210 is depressed, air from region 250 between the dome and the contact pads can be expelled into openings 232. In some embodiments, spacer 208 can instead or in addition include openings (e.g., opening 209) extending from the dome-contact pad interface into which air can be expelled. If dome switch 200 includes openings in both layer 230 and spacer 208, the openings can be aligned (e.g., to form larger regions for receiving displaced air) or offset (e.g., to define a larger number of regions into which air can be displaced).

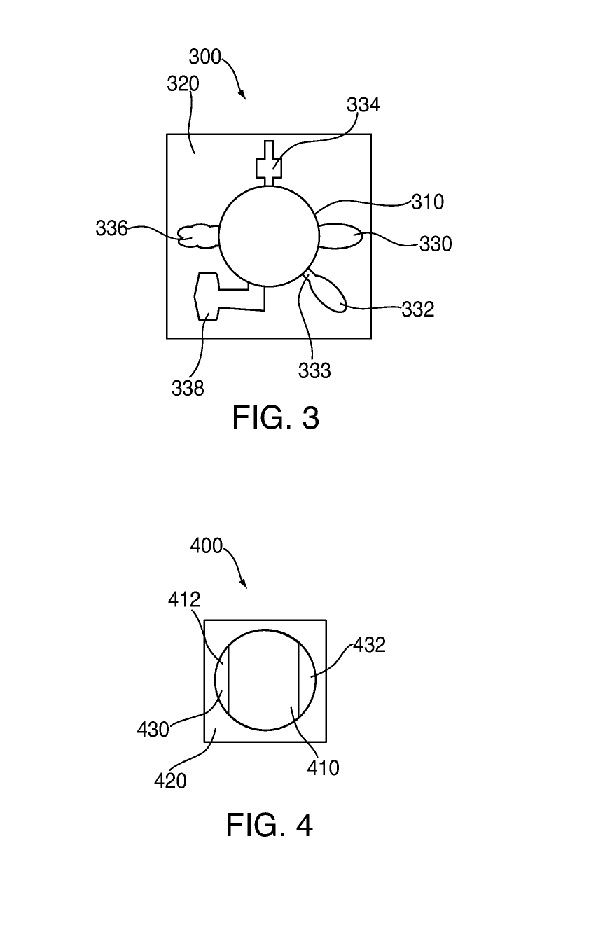

The reservoirs or regions into which air can be displaced can have any suitable size, and can be distributed around dome 210 using any suitable approach. FIG. 3 is a top view of an illustrative dome switch that includes a reservoir for receiving air expulsed by a dome during actuation in accordance with one embodiment of the invention. Dome switch 300 can include dome 310 retained via film 320 to a circuit board or other electronic device component having contact pads. To receive air expulsed from underneath dome 310 when the dome is depressed, one or more reservoirs 330, 332, 334 or 336 can be connected to the region underneath dome 310 and retained within film 320. In some embodiments, a portion of a reservoir can extend beyond the boundary of film 320. Each reservoir can connect to dome 310 using any suitable approach. For example, a portion of a reservoir (e.g., reservoirs 330, 334, 336 and 338) can directly extend to dome 310. As another example, a reservoir body can connect to the dome using a via, passageway or path 333.

Dome switch 300 can have any suitable number of reservoirs. For example, dome switch 300 can have at least four reservoirs extending in four cardinal directions. As another example, dome switch 300 can have reservoirs extending in different directions based on the position of dome switch 300 within an electronic device, and based on the space required by other components of the device (e.g., a reservoir extends away from other circuitry of a circuit board). In some embodiments, the number of reservoirs can be selected in relation with the size of the reservoirs. In particular, it may be desirable to provide at least a minimum reservoir volume into which air can be displaced. The minimum reservoir volume can be determined based on any suitable criteria, including for example the amount of air to displace (e.g., determined from the difference in volume underneath the dome when the dome is raised and when the dome is depressed), a desired maximum air pressure resistance to the dome displacement (e.g., determined from the change in density of the air within dome switch 300), and size limitations of the dome switch within the device.

Individual reservoirs can have any suitable size or shape. For example, a reservoir can have a generally curved shape, such as circles or ovals (e.g., oval reservoirs 330 and 332). As another example, a reservoir can have a generally polygonal shape, such as triangles, rectangles or squares (e.g., cross-shaped reservoir 334). As still another example, a reservoir can have an arbitrary shape (e.g., cloud-shaped reservoir 336 and L-shaped reservoir 338). In some embodiments, the shape of a reservoir can be determined by the positions of other components within the device. For example, reservoir 338 can include a bend for accommodating another component.

FIG. 4 is a top view of an illustrative dome switch having a reservoir for receiving expelled air in accordance with one embodiment of the invention. Dome switch 400 can include dome 410 coupled to a circuit board using film 420. To reduce or limit the planar footprint of the dome switch, dome 410 can have a shape other than a circular or oval shape. For example, dome 410 can include one or more regions 412 cut out from the circular dome shape (e.g., forming a rectangle with two opposite curved edges) The cutouts can have any suitable shape and size, and leave any suitable shaped dome (e.g., a rectangular dome). To maintain a traditional dome switch footprint (e.g., substantially constrained to the dimensions of the dome), dome switch 400 can include reservoirs 430 and 432 extending in one more of cutout regions 412. Each reservoir can cover any suitable amount of the cutout regions, including for example an amount determined from a minimum volume required for air displacement (e.g., use less than the cutout area if less is needed to displace air from underneath dome 410).

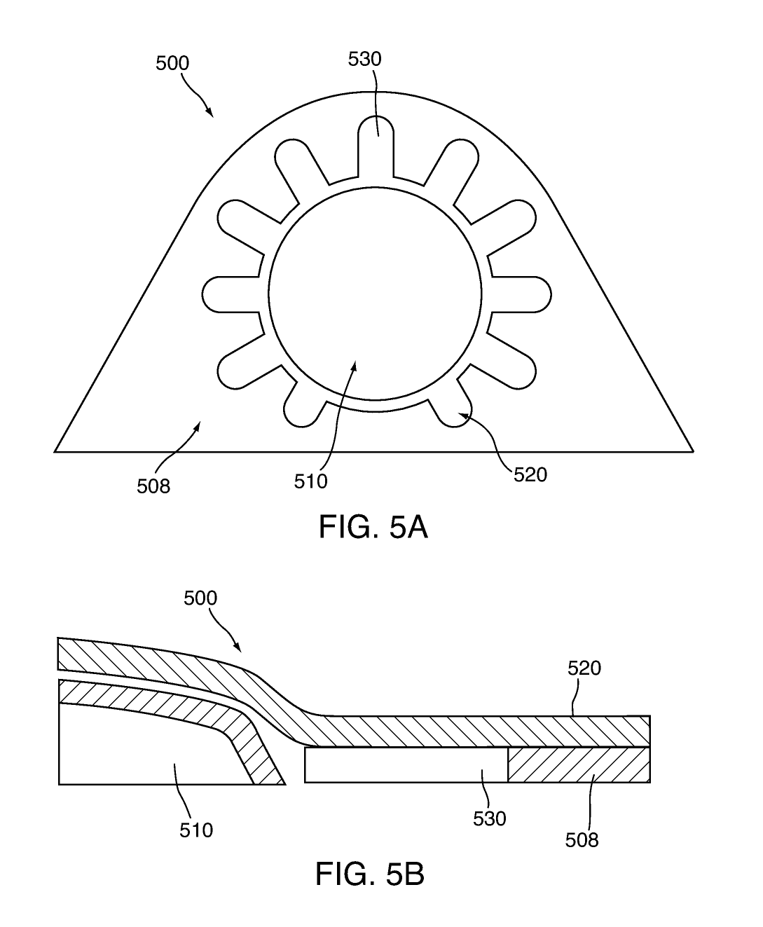

FIG. 5A is a bottom view of an illustrative dome switch having a reservoir constructed in a spacer in accordance with one embodiment of the invention. FIG. 5B is a cross-sectional view of the dome switch of FIG. 5A in accordance with one embodiment of the invention. Dome switch 500 can include dome 510 placed over spacer 508. Spacer 508 can include one or more channels 530 surrounding the periphery of dome 510 such that the channels can be in communication with the dome. Spacer 508 and dome 510 can be covered by film 520, such that film 520 provides an upper boundary over channels 530, thus creating a volume into which air can be expelled. Dome switch 500 can include any suitable number of channels 530 having any suitable size. For example, dome switch 500 can include a regular distribution of channels 530 (e.g., a symmetrical distribution). As another example, dome switch 500 can include a distribution of channels 530 having different sizes, where the size of each channel is determined from the space available between dome 510 and the external boundary of spacer 508. The particular number and size of the channels 530 can be determined from, for example, the size of the dome or the amount of air to vent during operation of the switch (e.g., as calculated from the dome travel).

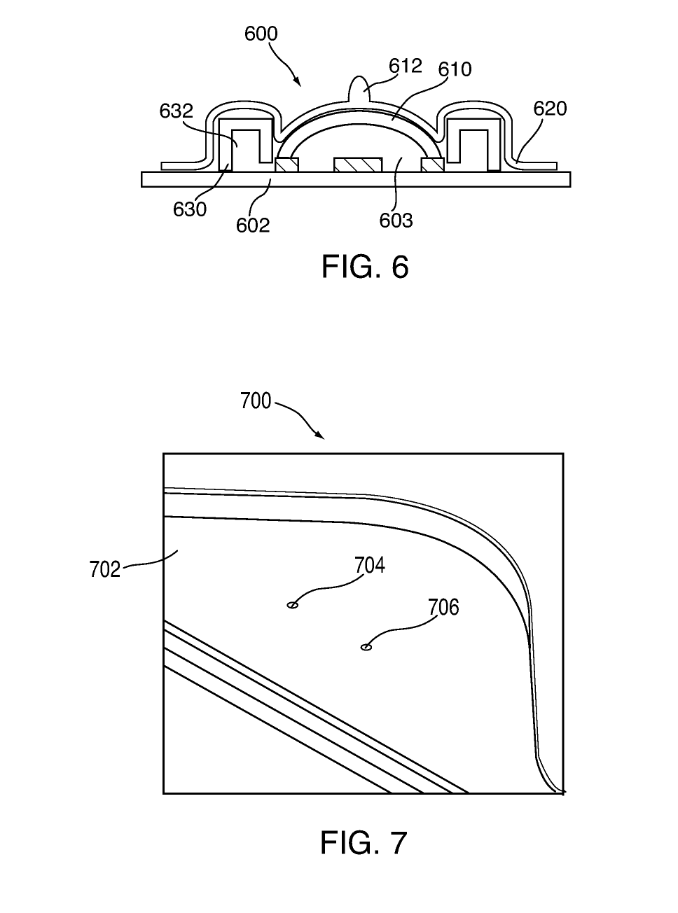

In some embodiments, a dome switch can include a reservoir that extends out of the plane of the dome to maintain a small dome switch footprint. FIG. 6 is a cross-sectional view of an illustrative dome switch having a reservoir extending along the dome height in accordance with one embodiment of the invention. Dome switch 600 can include dome 610 placed over circuit board 602. The dome can be coupled to the circuit board using film 620 connected to both the dome and circuit board, for example using an adhesive. In some embodiments, film 602 can only be coupled to the circuit board using an adhesive.

When dome 610 is depressed, volume 603 underneath the dome can be reduced, and excess air can be expelled from underneath the dome. The expelled air can be received by reservoir 632 of layer 630. Reservoir 632 can be positioned around any suitable region of dome 610, including for example around the entire periphery of the dome (e.g., a disk-like reservoir) or around discrete portions of dome 610 (e.g., on specific sides or areas based on the space available for the dome within an electronic device). To reduce the footprint of dome switch 600, reservoir 632 can have a small width or thickness (e.g., along an axis extending from the center of dome 610 and in the plane of circuit board 602), but a large height (e.g., along an axis perpendicular to the plane of circuit board 602). For example, the height of reservoir 632 can be the same, 2 to 10 times, 3 to 8 times, or 4 times the width or thickness of reservoir 632.

The height of reservoir 632 can be selected based on any suitable criteria, including for example a desired reservoir volume. In some embodiments, the height of reservoir 632 can be selected such that the height is less than the depressed or released height of layer 630. This can ensure that reservoir 632 does not interfere with the operation of a dome 610. In some embodiments, dome 610 can instead or in addition include nub 612 extending from the top surface of dome 610 such that nub 612 can extend beyond the height of reservoir 632.

In some embodiments, the dome switch can instead or in addition include a via or conduit from the region below the dome to a reservoir incorporated in the electronic device. For example, the electronic device can include a reservoir incorporated in a circuit board, or in an adhesive layer placed adjacent to the dome switch. FIG. 7 is a schematic view of an illustrative circuit board over which a dome switch is placed in accordance with one embodiment of the invention. Circuit board 702 can include vias 704 and 706 positioned on an area of the circuit board that is covered by a dome. Vias 704 and 706 can provide a path to a reservoir in another component of the electronic device (e.g., another layer in the stack that includes the dome switch). For example, vias 704 and 706 can provide a path to a reservoir in an adhesive layer.

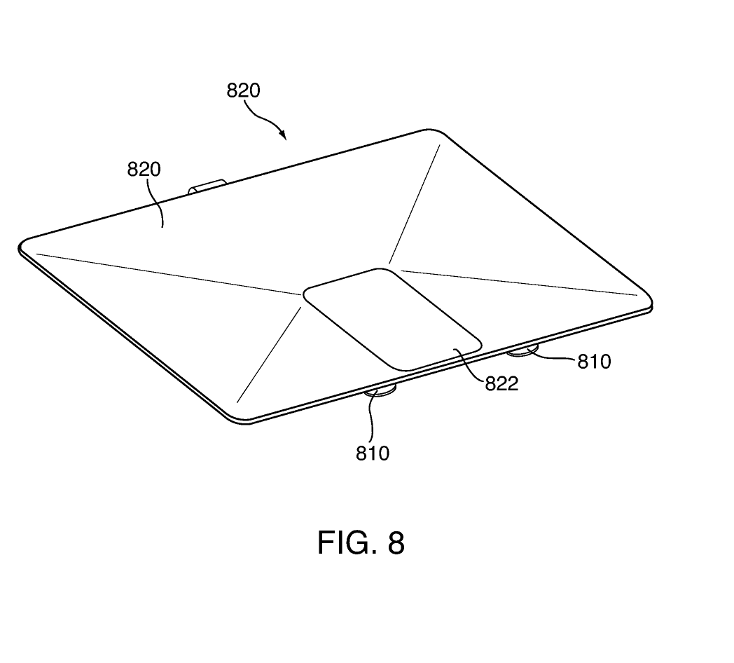

FIG. 8 is a schematic view of an illustrative adhesive layer having a reservoir in accordance with one embodiment of the invention. Device structure 800 can include dome switch region 810. Device structure 800 can also include adhesive layer 820 placed near or in a stack with dome switch region 810. Adhesive layer 820 can include cored reservoir 822 into which air expelled by a dome can propagate.

In some embodiments, the volume required for expelling air from underneath the dome can be relatively small. In such cases, the circuit board receiving the dome switch can include several vias, where the volume of the vias is sufficient to receive expelled air. Alternatively, the circuit board can include a cored region between the conductive contact pads into which air can be received. For example, material between the contact pads (e.g., material from the isolating region of the circuit board on which conductive traces are placed) can be etched or machined away to form reservoirs.

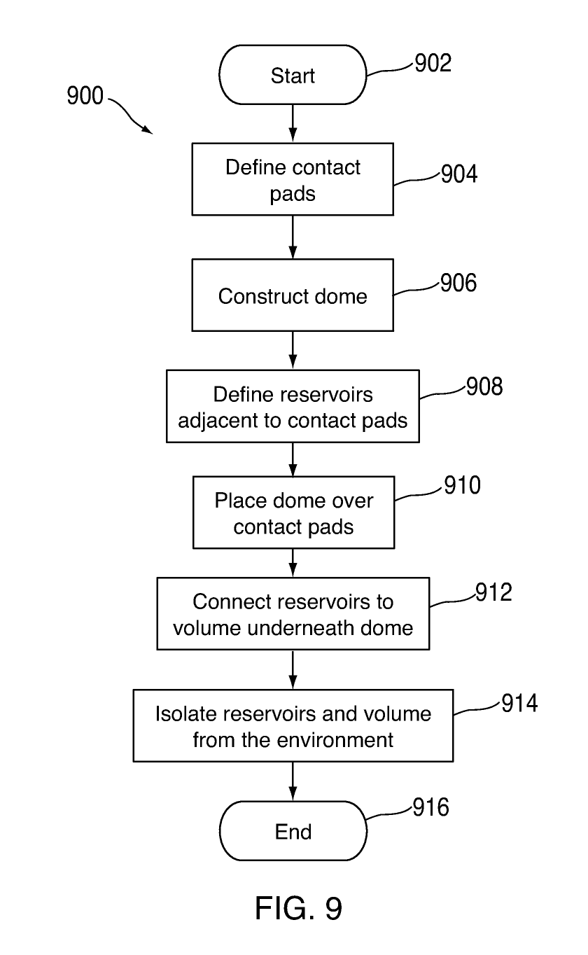

FIG. 9 is a flowchart of an illustrative process for constructing a ventless dome switch in accordance with one embodiment of the invention. Process 900 can begin at step 902. At step 904, contact pads can be defined. For example, at least two electrically isolated contact pads can be constructed on a circuit board. At step 906, a dome can be constructed. For example, a sheet of conductive material can be stamped to form a dome. As another example, a conductive coating can be applied to an isolating material formed in a dome. At step 908, reservoirs can be defined adjacent to the contact pads. For example, one or more reservoirs can be constructed and in contact with a contact pad. The reservoirs can be constructed from any suitable material, including for example from a film-like material, a spacer material, an adhesive layer, or combinations of these. In some embodiments, a reservoir can be connected to the an area adjacent the contact pads by a via or passageway.

At step 910, the dome can be placed over the contact pads. For example, the dome can be positioned such that the periphery of the dome is over a first contact pad and the center of the dome can be deflected to reach a second contact pad. At step 912, the reservoirs can be connected to a volume underneath the dome (e.g., between the dome and the circuit board). The volume may define the region from which air is to be expulsed when the dome switch is actuated. The reservoirs can be connected to the volume using any suitable approach. In some embodiments, the position and shape of the reservoirs (e.g., as set at step 908) can predispose the reservoirs to be connected to the volume. At step 914, the reservoirs and volume can be isolated from the environment. For example, a film (e.g., an impermeable film) can be placed over the dome such that air initially within the dome and reservoirs remains within the dome and reservoirs. In one implementation, the film can be adhered to the circuit board in a manner that surrounds the periphery of the dome. Process 900 can then end at step 916.

The above described embodiments of the present invention are presented for purposes of illustration and not of limitation, and the present invention is limited only by the claims which follow.

What is claimed is:

1. A dome switch comprising:
a circuit board comprising at least two contact pads;
a dome placed over the circuit board and aligned with the at least two contact pads;
a reservoir adjacent to the dome; and
an outer film disposed over the circuit board, dome and reservoir, such that air trapped between the dome and the circuit board is expelled into the reservoir.

2. The dome switch of claim 1, wherein:
air trapped between the dome and the circuit board cannot escape out of the reservoir.

3. The dome switch of claim 1, further comprising:
a spacer placed between the circuit board and the outer film, wherein the spacer surrounds the dome.

4. The dome switch of claim 3, wherein:
the spacer comprises at least one cutaway region, wherein a portion of the cutaway region extends to an interface between the circuit board and the dome.

5. The dome switch of claim 3, wherein:
the reservoir is integrated in the spacer.

6. The dome switch of claim 1, wherein the reservoir further comprises:
a body for receiving expelled air; and
a passageway connecting the reservoir body to an interface between the circuit board and the dome.

7. The dome switch of claim 1, further comprising:
an intermediate film layer placed between the outer film and the circuit board, wherein the reservoir is integrated in the intermediate film layer.

8. The dome switch of claim 1, wherein:
the reservoir volume is selected based on the size of the dome.

9. A method for constructing a ventless dome switch, comprising:
selecting a dome having a particular size;
determining a minimum volume for receiving air displaced from underneath the dome when the dome is depressed;
defining a reservoir having at least the minimum determined volume;
positioning the reservoir adjacent to the dome such that air displaced from underneath the dome is directed to the reservoir; and
applying an impermeable film over the dome and the reservoir to isolate the air within the dome switch and reservoir.

10. The method of claim 9, further comprising:
defining several reservoirs having a combined volume of at least the minimum determined volume.

11. The method of claim 9, further comprising:
forming two contact pads separated by an isolating region; and
positioning the dome over the two contact pads, such that the dome is in contact with both of the contact pads when the dome is depressed.

12. The method of claim 11, wherein:
the two contact pads are formed on a circuit board.

13. The method of claim 12, further comprising:
applying the impermeable film over the dome and circuit board, wherein the film covers the entirety of the dome and extends beyond the periphery of the dome.

14. The method of claim 12, further comprising:
applying a layer of material on the circuit board in the vicinity of the contact pads, wherein the layer comprises at least one cut out; and
placing the impermeable film over the layer of material, wherein the cut out in the layer of material forms the reservoir.

15. The method of claim 9, wherein:
the shape of the reservoir is one of:
a polygonal shape;
an elliptical shape; and
an arbitrary shape.

16. A reservoir for receiving air expelled by a dome switch when the dome is depressed, comprising:
a via having a first end exposed within the dome volume enclosed between the dome and a circuit board on which the dome is placed; and
an impermeable reservoir body connected to a second end of the via, wherein the reservoir body receives all air expelled from the volume when the dome is depressed.

17. The reservoir of claim 16, wherein:
the reservoir body extends along a plane of the circuit board.

18. The reservoir of claim 17, wherein:
the reservoir body is placed on a surface of the circuit board.

19. The reservoir of claim 16, wherein:
the height of the reservoir body is at least the height of the dome when it is not depressed.

20. The reservoir of claim 16, wherein:
the height of the reservoir body is larger than the width of the reservoir body.

21. A dome switch arrangement, comprising:
a substrate;
a dome placed over the substrate to define a first internal volume, wherein the dome moves inwardly into the first internal volume when actuated; and
a fluid overflow assembly creating a second internal volume, the second internal volume being in fluid communication with the first internal volume, the second internal volume accepting air from the first internal volume when the dome is moved inwardly into the first internal volume.
